(19) United States
(12) Patent Application Publication
(10) Pub. No.: US 2026/0208708 A1
(43) Pub. Date: Jul. 23, 2026

(54) SYSTEM AND METHOD FOR CONTROLLING PARKING BRAKE IN AN ELECTROMECHANICAL BRAKE (EMB) ASSEMBLY

(71) Applicant: HL MANDO CORPORATION, Gyeonggi-do (KR)

(72) Inventor: Gyunghun SIM, Auburn, MI (US)

(21) Appl. No.: 19/032,881

(22) Filed: Jan. 21, 2025

(51) Int. Cl. B60T 8/172; B60T 1/00; B60T 8/171; B60T 13/74; F16D 63/00; F16D 65/18; F16D 66/00; F16D 121/24; F16D 125/40; F16D 125/44; F16D 127/06

(52) U.S. Cl. CPC B60T 8/172; B60T 1/005; B60T 8/171; B60T 13/746; F16D 63/006; F16D 65/18; F16D 66/00; F16D 2066/003; F16D 2066/005; F16D 2121/24; F16D 2125/40; F16D 2125/44; F16D 2127/06

(57) ABSTRACT

An electromechanical brake (EMB) assembly includes: a brake pad assembly; an electric motor mechanically connected to the brake pad assembly via at least one gear having teeth to apply a parking brake to place the EMB assembly in a parking brake enabled state; a parking lock mechanism that includes a parking pawl that prevents release of the brake pad assembly from the parking brake enabled state; and a controller electrically connected to the electric motor and configured to control the electric motor to re-apply the parking brake in response to the controller determining that the parking pawl will be or is already engaged with the teeth of the at least one gear in an unstable parking brake state.

### BACKGROUND

Various embodiments of the present disclosure generally relate to an electromechanical brake system and more particularly to a system and method for controlling a parking brake of the electromechanical brake system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” and electric or “brake by wire.” For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Generally, the brake system may include a service brake assembly and a parking brake assembly. The parking brake assembly may be used to prevent movement of the vehicle when a vehicle is stopped or parked. The parking brake assembly may be a discrete assembly, or may utilize one or more components of the service brake assembly. That is, the parking brake assembly may use the piston and the brake pads of the service brake assembly to create the brake apply. For example, the parking brake assembly may move the piston, which may move the brake pads into contact with the rotor to create and maintain a brake apply by clamping force applied to the rotor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: a brake pad assembly; an electric motor mechanically connected to the brake pad assembly via at least one gear having teeth to apply a parking brake to place the EMB assembly in a parking brake enabled state; a parking lock mechanism comprising a parking pawl that prevents release of the brake pad assembly from the parking brake enabled state; and a controller electrically connected to the electric motor and configured to control the electric motor to re-apply the parking brake in response to the controller determining that the parking pawl will be or is already engaged with the teeth of the at least one gear in an unstable parking brake state.

The unstable parking brake state comprises a terminal end of the parking pawl that engages with the teeth of the at least one gear being engaged against a top land of a gear tooth among the teeth of the at least one gear.

The re-applying of the parking brake prevents the parking pawl from being engaged against the top land of the gear tooth to place the parking pawl between a notch between the teeth of the at least one gear.

The determination by the controller is based on a position of the electric motor measured by the controller before a ramping down of a motor torque that occurs when the parking brake is applied.

The determination by the controller comprises, by the controller: measuring a first motor position of the electric motor before the ramping down of the motor torque that occurs when the parking brake is applied; measuring a second motor position of the electric motor after a predetermined time after the ramping down of the motor torque; and using the first motor position and the second motor position to determine whether the parking pawl is engaged with the teeth of the at least one gear in the unstable parking brake state.

The determination by the controller further comprises, by the controller: calculating a difference between the second motor position and the first motor position; comparing the difference to a predetermined motor position difference threshold; in a first instance where the difference exceeds the predetermined motor position difference threshold, determining that the parking pawl is not engaged with the teeth of the at least one gear in the unstable parking brake state; and in a second instance where the difference is below the predetermined motor position difference threshold, determining that the parking pawl is engaged with the teeth of the at least one gear in the unstable parking brake state.

The determination by the controller further comprises, by the controller: determining that the first motor position is substantially identical to the second motor position; and determining, based on the first motor position being substantially identical to the second motor position, that the parking pawl is engaged with the teeth of the at least one gear in the unstable parking brake state.

The controller further measures the motor torque as the parking brake is applied, and the second motor position is measured when the controller determines that the motor torque has decreased by at least half from a maximum motor torque measured by the controller after the parking brake is applied.

The controller further measures the motor torque as the parking brake is applied, and the second motor position is measured when the controller determines that the motor torque has decreased by at least a quarter from a maximum motor torque measured by the controller after the parking brake is applied.

The controller further measures the motor torque as the parking brake is applied, and the second motor position is measured when the controller determines that the motor torque has decreased to an original motor torque measured by the controller at an instant before the motor torque began to ramp up at a start of an application of the parking brake.

The parking pawl is pivotable about a pivot axis between an engaged position where the parking pawl is in contact with the at least one gear and a disengaged position where the parking pawl is not in contact with the at least one gear, and the parking pawl cannot be directly controlled by the controller to pivot between the disengaged position and the engaged position.

The parking pawl is only pivotable between the disengaged position and the engaged position based on a movement of the at least one gear when the parking brake is applied.

The determination by the controller is based on an angle of each of the teeth of the at least one gear at a time when the parking brake is applied.

The angle of each of the teeth is based on an angle of the electric motor.

The controller uses the angle of each of the teeth at the time when the parking brake is applied to determine a parking pawl safe position and a position of the parking pawl between the teeth.

The controller further: determines whether a target clamp force has been reached after the parking brake is applied; and determines when the target clamp force has been reached, whether the parking pawl will be engaged with the teeth of the at least one gear in the unstable parking brake state using the parking pawl safe position and the position of the parking pawl between the teeth.

In an event that the controller determines that the parking pawl will be engaged with the teeth of the at least one gear in the unstable parking brake state, the controller causes the electric motor to move the at least one gear until the parking pawl reaches at least one safe area indicated by the parking pawl safe position.

In an event that the controller determines that the parking pawl will not be engaged with the teeth of the at least one gear in the unstable parking brake state, the controller causes the EMB assembly to actuate the parking pawl to engage with the at least one gear between at least one notch of the teeth of the at least one gear.

According to some embodiments of the present disclosure, a method of controlling a parking brake of an electromechanical brake (EMB) assembly may comprise: determining, by an electronic controller of an electromechanical brake (EMB) assembly, that a parking pawl of the EMB assembly will be or is already engaged with a tooth of at least one gear of the EMB assembly in an unstable parking brake state; and controlling, by the electronic controller and in response to the determination, an electric motor that drives the at least one gear to re-apply a parking brake of the EMB assembly to prevent the EMB assembly from entering or to remove the EMB assembly from the unstable parking brake state.

The electric motor is mechanically connected to a brake pad assembly of the EMB assembly via the at least one gear having teeth to apply the parking brake to place the EMB assembly in a parking brake enabled state, and parking pawl is part of a parking lock mechanism that prevents release of the brake pad assembly from the parking brake enabled state.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of an electromechanical brake (EMB) assembly according to an exemplary embodiment of the present disclosure.

FIGS. 2A-2C show diagrams illustrating a first example of controlling a parking brake of an EMB assembly according to an exemplary embodiment of the present disclosure.

FIGS. 3A-3C and 4 show diagrams illustrating a second example of controlling a parking brake of an EMB assembly according to an exemplary embodiment of the present disclosure.

FIG. 5 shows a flow chart for illustrating a method for controlling a parking brake of an EMB assembly according to an exemplary embodiment of the present disclosure.

FIG. 6 shows a schematic view of a vehicle including a steering system and a brake assembly according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

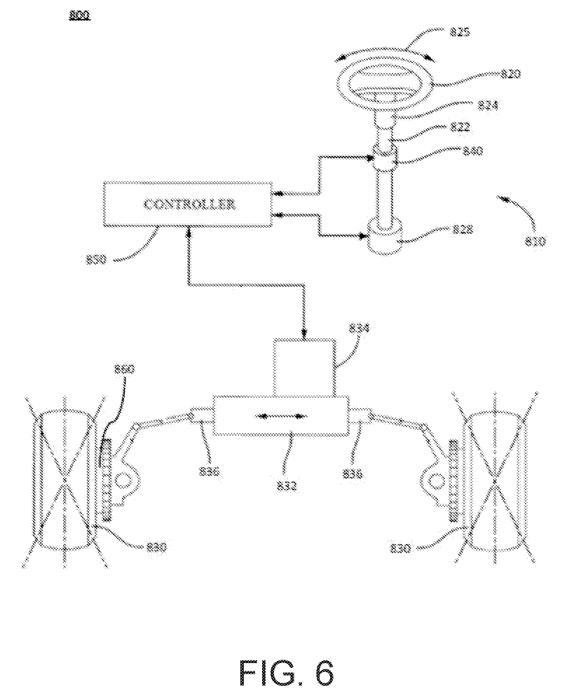

A vehicle (see, e.g., FIG. 6) is equipped with a parking brake to prevent movement of wheels when the vehicle is not in operation, for instance, when the vehicle is stopped or parked. The parking brake may refer to a mechanism for restraining or holding a parked vehicle in place. The parked status of the vehicle can be maintained by a parking lock mechanism, for example, but not limited to, a strut, a parking pawl, engagement of one or more gears, and so on. A reliable parking brake operation is particularly important for safety. However, when the vehicle is not in operation, as when the parking brake is needed, the parking brake may be accidentally disengaged or released. For instance, the parking brake may not provide a force sufficient to clamp brake pads to prevent rolling of the vehicle, or the parking lock mechanism may not be appropriately engaged. A brake control system for controlling the parking brake needs to be designed to assure that the parking brake remains securely engaged.

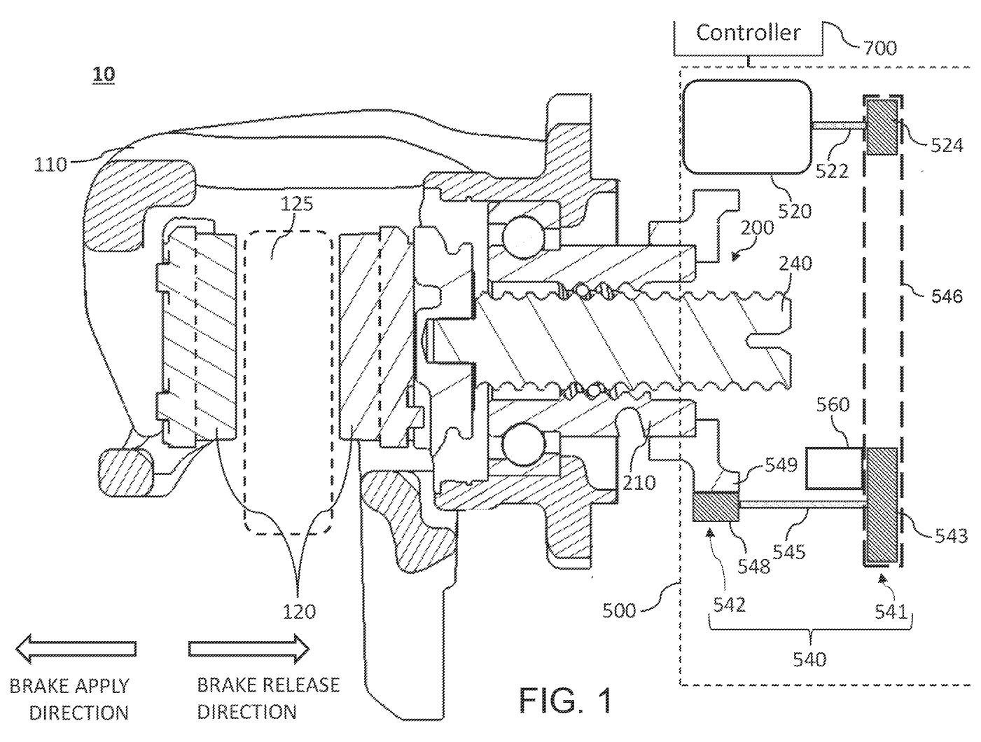

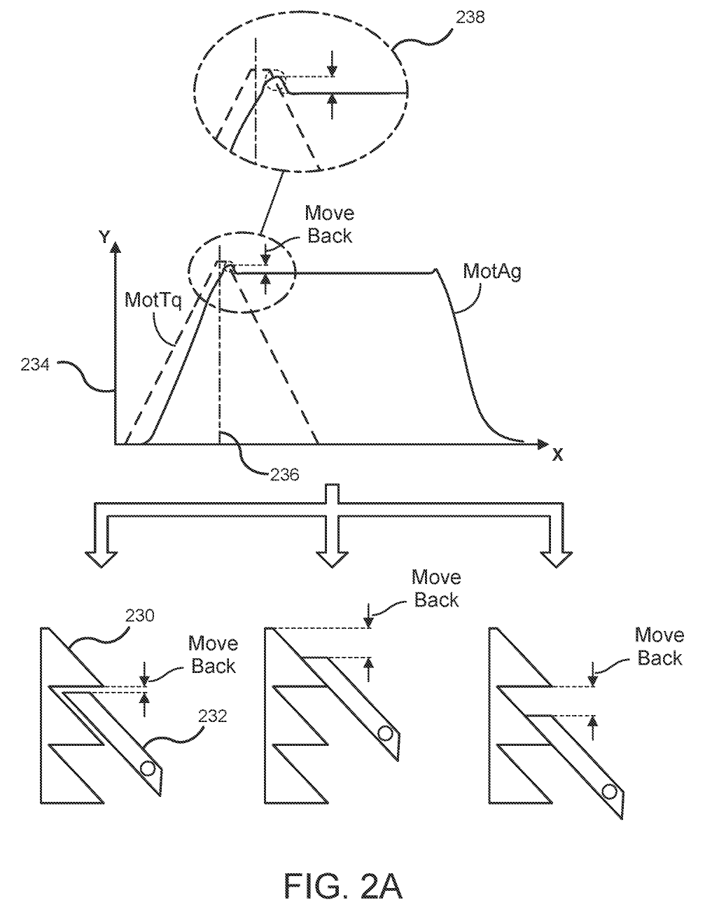

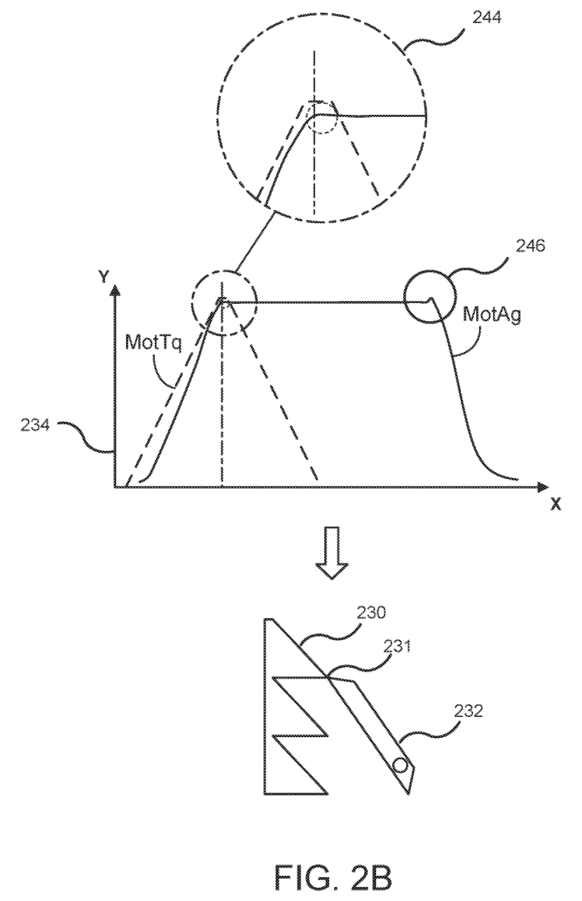

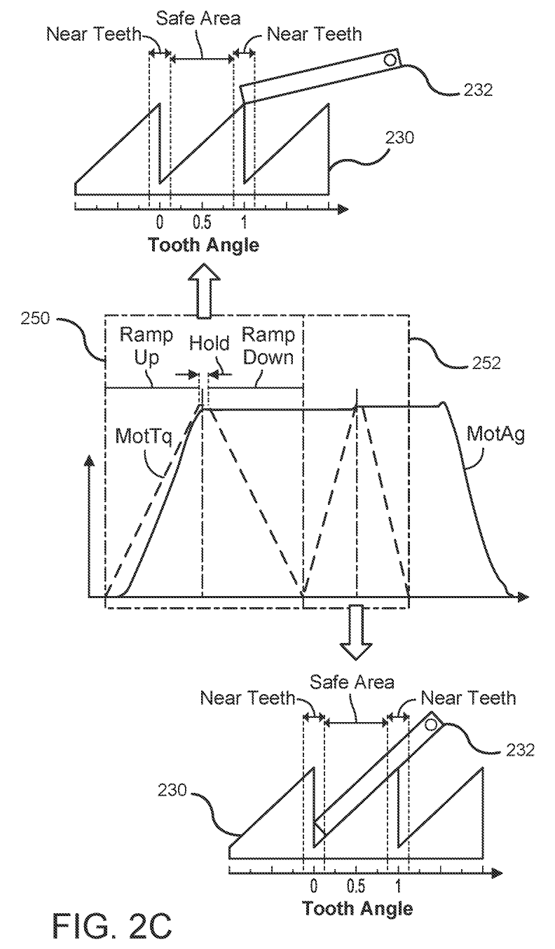

According to some embodiments of the present disclosure, when a parking brake of an electromechanical brake (EMB) assembly is applied, a latch-like structure (e.g., a latch, a parking pawl, or the like) engages with a gear (e.g., driven pulley 543 of FIG. 1, or the like) to prevent the gear from moving while the parking brake is applied. The latch-like structure may engage with the gear in a stable condition (e.g., a condition where there is little to no risk of the latch-like structure coming loose from the gear and allowing the gear to move, thus releasing the parking brake) or in an unstable condition (e.g., a condition where the latch-like structure could be shaken loose from the gear due to one or more unexpected external input on the vehicle causing the parking break to be unintentionally released). Examples of the stable condition and the unstable condition are shown below in refernce to FIGS. 2A-2C.

To prevent the parking brake from being applied in the unstable condition, various parameters and characteristics of both the gear, a motor that actuates the gear, and other mechanical components of the EMB assembly may be used to predict how the latch-like structure (e.g., latch, parking pawl, or the like) will potentially engage with the gear. Embodiments discussed below describe how application of the parking brake in the unstable condition can be detected and prevented to advantageously always guarantee that the parking brake will be applied in the stable condition.

Referring to FIG. 1, a brake assembly 10 may include a brake caliper 110 mounted in a floating manner by means of a brake carrier. In embodiments, the brake assembly 10 may be an EMB assembly, or the like. When the vehicle is in motion, a brake rotor 125 may rotate with a wheel about an axle of the vehicle. A brake pad assembly (or brake lining assembly) 120 is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable body 210 of the screw mechanism 200. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. In embodiments, the driven pulley 543 may be a gear having teeth, and may be configured to be actuated by electric motor 520. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism or screw-nut mechanism 200 or be mounted to the rotatable body 210 of the drive mechanism 200 to rotate the rotatable body or nut 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assemblies 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assemblies 120.

Additionally, if the parking brake is properly engaged by applying sufficient brake clamping force to the brake rotor 125 of the wheel, the motor torque generated by the electric motor 520 is decreased to allow a parking lock mechanism 560 to prevent moving the brake pad assembly 120 in the release direction. For instance, a strut, a parking pawl or a gear included in the parking lock mechanism 560 may be engaged with any component of the drive mechanism 200 or the actuator assembly 500, such as notches formed on a gear in order to lock the movement of the brake pad assembly 120. The details of exemplary embodiments of the parking lock mechanism 560 are described in U.S. Application No. 17/579,552, filed on January 19, 2022, and published as U.S. Patent Application Publication No. 2023/0228309 on July 20, 2023, the entire teachings of which are incorporated by reference herein.

Furthermore, the brake assembly 10 may further include a controller 700 (e.g., an electronic controller) that may be configured to control the electric motor 520 to perform the operation of the parking brake such as a parking brake application or a parking brake release. For instance, the controller 700 may control the electric motor 520 by controlling the inverters 511 connected between the power source 510 and the electric motor 520. The controller 700 may be, for example, but not limited to, a micro-controller unit (MCU), a circuit chip, a semiconductor circuit, and a circuit board having memory, one or more processors, and electric components.

In embodiments, the parking pawl may be pivotable about a pivot axis between an engaged position where the parking pawl is in contact with the at least one gear (e.g., driven pulley 543 of FIG. 1) and a disengaged position where the parking pawl is not in contact with the at least one gear. In embodiments, the parking pawl cannot be directly controlled by the controller 700 to pivot between the disengaged position and the engaged position. Alternatively, the parking pawl may be directly controller by the controller 700 (e.g., via a separate electric motor, or other actuating mechanisms) to pivot between the disengaged position and the engaged position. For example, the parking pawl may be actuated using a solenoid valve directly or indirectly controlled by the controller 700.

Turning now to FIGS. 2A-2C, FIGS. 2A-2C show diagrams illustrating a first example of controlling a parking brake of an EMB assembly according to an exemplary embodiment of the present disclosure.

As shown in FIG. 2A, a graph 234 is presented showing a change in motor torque MotTq and motor rotation MotAg (e.g., the y-axis of graph 234) over time (e.g., the x-axis of the graph 234) as the parking brake is applied. As shown in graph 234, as the parking brake is applied, the motor torque ramps up, holds still for a period of time, and then ramps down.

In embodiments, a parking pawl 232 (or other latch-like structure) is applied to engage with the gear 230 (e.g., driven pulley 543 of FIG. 1) at point 236 of graph 234. When the motor torque ramps down after such engagement between the gear 230 and the parking pawl 232, the motor rotation MotAg and a direction of movement of the gear 230 changes, causing a slight move back in the movement of the gear 230 such that the parking pawl 232 is able to be completely seated on the gear 230 (e.g., after the “move back”, a terminal end/surface of the parking pawl 323 furthest away from the pivoting mechanism may be seated against a flat surface of at least one tooth of the gear 230).

This slight move back in the movement of the gear is shown in the blow-up portion 238 of the graph 234 where the motor rotation MotAg is shown to dip slightly after reaching a peak point of movement. This dip (e.g., change) in the change in motor rotation MotAg indicates that the parking pawl 232 is completely seated on the gear 230 in one of the three example positions shown in FIG. 2A. All three example positions shown in FIG. 2A show the parking brake being engaged in a stable condition (also referred to herein as a “stable parking brake state”) where the parking pawl 232 is in little to no risk of disengaging with (e.g., falling out form) the gear 230 when one or more unexpected external input is applied to the vehicle while the vehicle is parked.

In embodiments, such motor torque MotTq and motor rotation MotAg may be monitored by the controller 700 via one or more sensors (not shown) (e.g., torque sensors, rotation sensors, movement sensors, or the like) that are installed within the brake assembly 10 within a predetermined proximity of the electric motor 520 and that are configured to sense various characteristics and properties of the electric motor 520.

On the other hand, as shown in FIG. 2B, another instance of graph 234 is shown where the parking pawl 232 engages with the gear 230 in an unstable condition (also referred to herein as a “unstable parking brake state”). In this unstable condition, the parking pawl 232 engaged with a top land 231 of a gear tooth of the gear 230. The top land 231 may be any surface at the top-most tip (e.g., a terminal end) of a gear tooth of the gear 230. If any portion of the parking pawl 232 engages with the top land 231 of a gear tooth of the gear 230, the parking pawl 232 is at risk of being dislodged from (e.g., disengaged with) the gear 230 when one or more unexpected external input is applied to the vehicle while the vehicle is parked, which causes the parking brake to come undone (e.g., become released). This could be dangerous if the vehicle is parked in position that could cause it to move (e.g., on a slope, or the like) if the parking brake comes undone.

As shown in the blown-up portion 244 of the other instance of graph 234 of FIG. 2B, when the parking pawl 232 engages with the gear 230 in the unstable condition, the motor rotation MotAg shows little to no change (e.g., as compared to the dip in the motor rotation MotAg shown in FIG. 2A) after reaching a peak value as the motor torque MotTq begins to ramp downward. This is because the parking pawl 232, when engaged with the top land 231 of a tooth of the gear 230, prevents the electric motor 520 from rotating to cause the change in the direction of movement of the gear 230. Thus, until the parking brake is released again at point 246 of the graph 234, the motor rotation MotAg will remain the same (e.g., show no change).

Using such changes in the motor torque MotTq and motor rotation MotAg as measured by the controller 700, the unstable condition of the parking brake can be advantageously detected to prevent the brake assembly 10 from entering into the unstable condition (e.g., the unstable parking brake state).

Such prevention and removal of the parking brake from the unstable parking brake state is shown in FIG. 2C. In particular, FIG. 2C shows another instance of graph 234 of FIGS. 2A-2B where the parking brake is removed from the unstable parking brake state 250 into a stable parking brake state 252.

As shown in FIG. 2C, the controller 700 may determine from the changes in motor torque MotTq and motor rotation MotAg that the parking pawl 232 is engaged with the gear 230 in unstable parking brake state 250.

For example, the controller 700 may: measure a first motor position MotAg of the electric motor 520 before the ramping down of the motor torque MotTq that occurs when the parking brake is applied (and the parking pawl is engaged); measure a second motor position MotAg of the electric motor 520 after a predetermined time after the ramping down of the motor torque MotTq; and using the first motor position and the second motor position to determine whether the parking pawl 232 is engaged with the teeth (namely the top land 231 of the teeth) of the at least one gear 230 in the unstable parking brake state.

The first motor position and second motor position may be used to determine whether the parking pawl 232 is engaged with the teeth (namely the top land 231 of the teeth) of the at least one gear 230 in the unstable parking brake state by, for example: calculating a difference between the second motor position and the first motor position; comparing the difference to a predetermined motor position difference threshold; in a first instance where the difference exceeds the predetermined motor position difference threshold, determining that the parking pawl 232 is not engaged with the teeth of the at least one gear 230 in the unstable parking brake state 250; and in a second instance where the difference is below the predetermined motor position difference threshold, determining that the parking pawl 232 is engaged with the teeth of the at least one gear 230 in the unstable parking brake state 250.

Alternatively, the first motor position and second motor position may be used to determine whether the parking pawl 232 is engaged with the teeth (namely the top land 231 of the teeth) of the at least one gear 230 in the unstable parking brake state by, for example: determining that the first motor position is substantially identical to the second motor position; and determining, based on the first motor position being substantially identical to the second motor position, that the parking pawl 232 is engaged with the teeth of the at least one gear 230 in the unstable parking brake state 250.

In embodiments, the controller 700 may measure the motor torque as the parking brake is applied (e.g., when the parking pawl 232 is caused to become engaged with the gear 230). The second position may be measured when the controller 700 determines that the motor torque MotTq has decreased by at least half from a maximum motor torque measured by the controller after the parking brake is applied. Alternatively, the second motor position may be measured when the controller 700 determines that the motor torque MotTq has decreased by at least a quarter from a maximum motor torque measured by the controller after the parking brake is applied. Other amounts of motor torque MotTq decrease (e.g., 1%, 5%, 10%, or 100% decrease where the motor torque MotTq has decreased to an original motor torque measured by the controller 700 at an instant before the motor torque MotTq began to ramp up at a start of an application of the parking brake, or the like) may also be used as a setpoint for measuring the second motor position without departing from the scope of embodiments disclosed herein.

Once the controller 700 has determined that the parking pawl 232 is engaged with the teeth of the at least one gear 230 in the unstable parking brake state 250. The controller 700 may cause the parking brake to be reengaged. Such reengagement of the parking brake may cause the motor torque MotTq to ramp up, hold still, and ramp down again. Such reengagement may also cause the parking pawl 232 to fall into a space between the teeth of the gear 230, as originally intended, to bring the brake assembly 10 into the stable parking brake state 252.

As shown in the stable parking brake state 252 portion of the graph of FIG. 2C, after the parking pawl 232 is released from being engaged with the top land 231 of a tooth of the gear 230 and falls into the space between the teeth of the gear 230, the electric motor 520 is able to rotate slightly to cause the change in the direction of movement of the gear 230, which causes a slight increase in the motor rotation MotAg to be measured (e.g., the slight bump upwards in the MotAg when the MotTq is about to peak in the stable parking brake state 252 portion of the graph of FIG. 2C) when the parking brake is reapplied.

Thus, using the measured motor torque MotTq and motor rotation MotAg, the controller 700 is advantageously able to determine whether the parking pawl 232 is engaged with the teeth of the at least one gear 230 in an unstable parking brake state 250 in order to automatically reapply the parking brake to remove the brake assembly 10 from the unstable parking brake state 250 into the stable parking brake state 252.

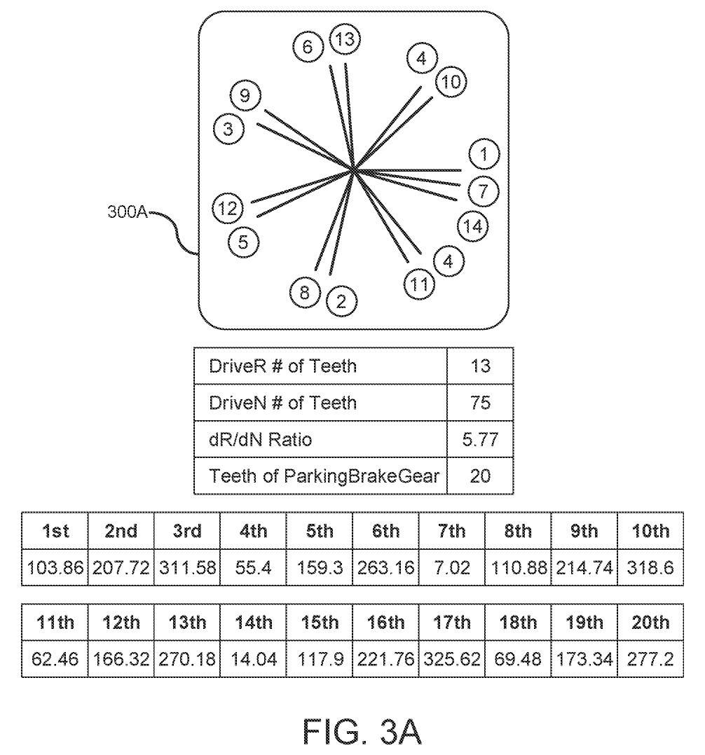

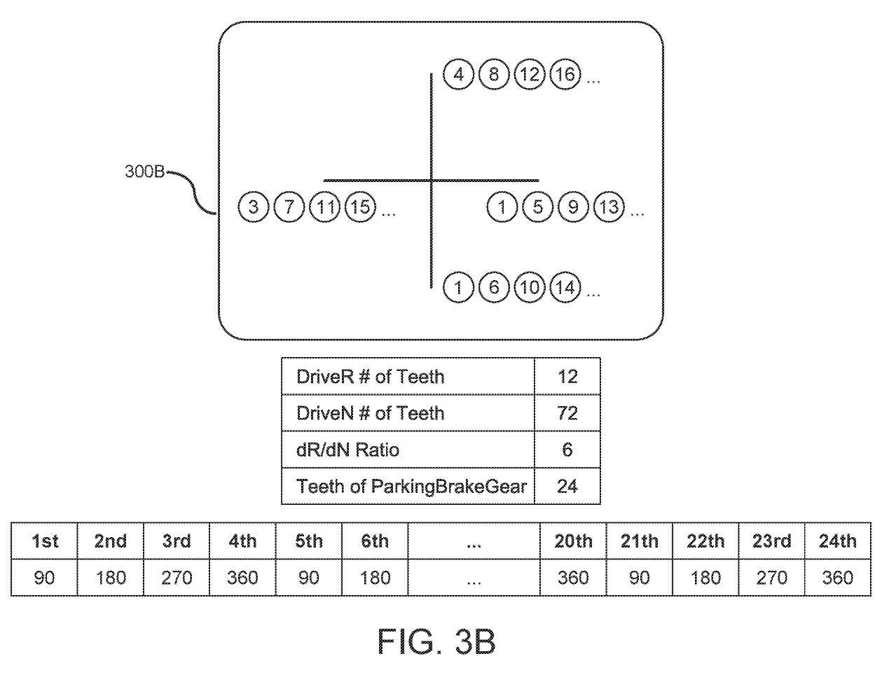

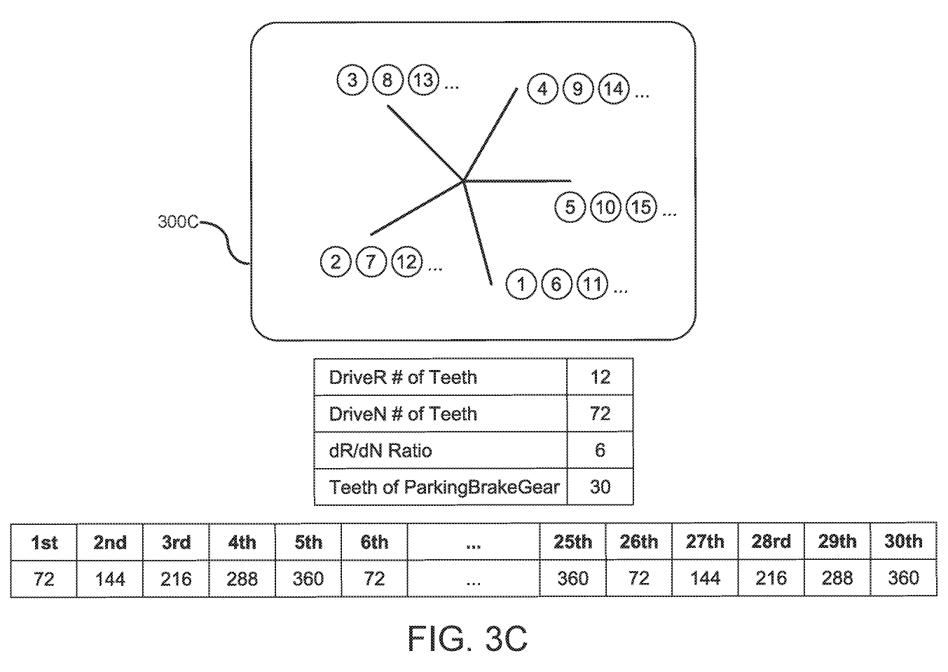

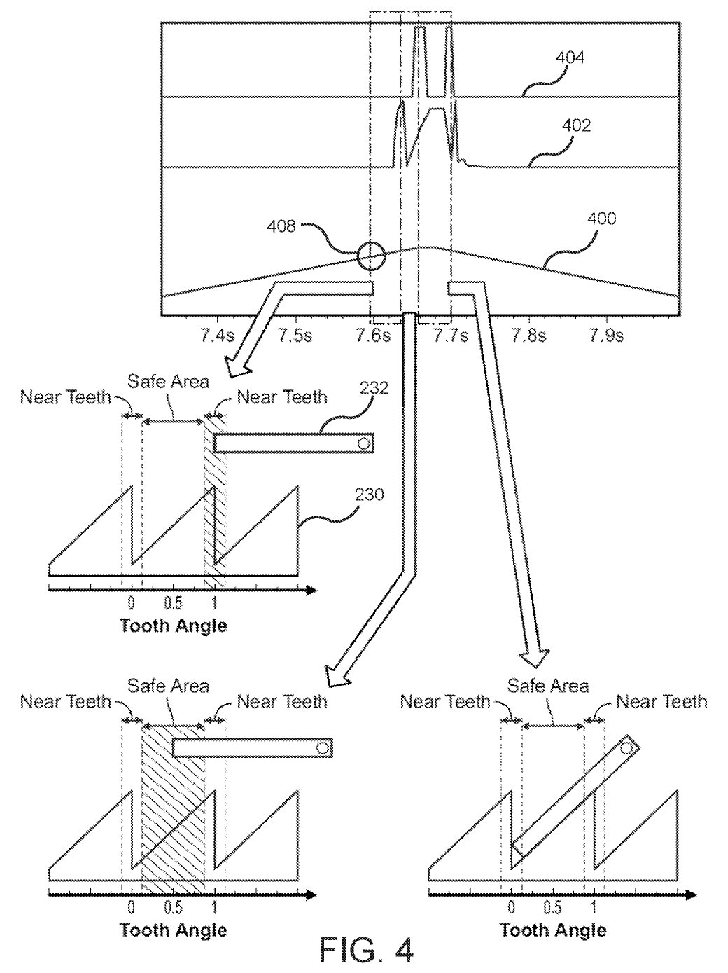

Turning now to FIGS. 3A-4, FIGS. 3A-4 show diagrams illustrating a second example of controlling a parking brake of an EMB assembly according to an exemplary embodiment of the present disclosure.

Starting with FIG. 3A, FIG. 3A shows a table an example gear ratio of a system and count of teeth for a parking brake of brake assembly 10. Assuming a gear ratio (e.g., dR/dN ratio) of 5.77, and when the motor rotates one turn, the rotation angle of the final gear will be 360/5.77 = 62.39. In this case, one parking brake tooth can be moved when the motor rotates 103.86 degrees. In other words, if the motor angle exceeds 360 degrees, the motor angle becomes 0 again. As a result, the angle for each tooth (e.g., the 1^{st} to the 20^{th} tooth) of the parking brake gear (e.g., driven pulley 543 of FIG. 1, or the like) is shown in the bottom tables of FIG. 3A.

As shown in this table of FIG. 3A, every angle has a different value as the teeth of the parking brake gear progresses. In this case, the controller 700 may be able to determine the position of each tooth as the electric motor 520 moves. As a result, a motor angle of the electric motor 520 that matches each tooth of the parking brake gear can be estimated by the controller 700. This is shown in the motor angle diagram 300A of FIG. 3A where each numbered tooth of the parking brake gear is shown to correspond to one motor angle.

In embodiments, the motor angle of the electric motor 520 may be obtained by one or more sensors (not shown), installed within the brake assembly 10 and coupled to controller 700, that are positioned and configured to measure (e.g., sense) the characteristics and movements of the electric motor 520.

Turning now to FIGS. 3B and 3C, if the gear ratio (dR/dN Ratio) and number of teeth of the parking brake gear is adjusted and then the teeth spacing is further adjusted to be an integer multiple of the rotation angle of a motor angle of the electric motor 520, the number of teeth passing when the motor rotates more than once can be adjusted to become constant. As a result, in FIG. 3B, the motor angle corresponding to one tooth gap of the parking brake gear is now 60 degrees while in FIG. 3C, the motor angle corresponding to one tooth gap of the parking brake gear is now 72 degrees. These are shown, respectively, in the motor angle diagrams 300B and 300C of FIGS. 3B and 3C.

As a result of such adjustments shown in FIGS. 3B and 3C, the positional relationship between the teeth (of the parking brake gear) and the motor angle can be estimated more accurately by the controller 700 using one or more operations (e.g., an Apply operation, using Set Point Position by confirmation logic, or the like).

Thus, using the tooth angles from FIGS. 3A-3C, the tooth of the parking brake gear that will engage with the parking pawl can be determined by the controller 700 based on the motor angle measured by the controller 700. Advantageously, the controller 700 may use this information to prevent the parking pawl from engaging with the tooth of the parking brake gear in the unstable parking brake state.

Such use of the motor angles to prevent the unstable parking brake state is shown in FIG. 4. In particular, as shown in FIG. 4, the clamp force 400 detected when the parking brake is applied is used in conjunction with a pawl position between teeth 402 and pawl safe position 404 graphs to determine where the parking pawl is (e.g., relative to one or more teeth of the parking brake gear 320) when the parking brake is applied.

The pawl position between teeth 402 and pawl safe position 404 graphs may be generated by the controller 700 using the known motor angle and teeth position information shown in the tables of FIGS. 3A-3C. In particular, the known motor angle and teeth position information shown in the tables of FIGS. 3A-3C may be applied to an algorithm (e.g., a detecting algorithm, an Apply operation, using Set Point Position by confirmation logic, or the like) that is able to use the known motor angle and teeth position information to calculate a relative position of the parking pawl 323 (to the parking brake gear 320) based on a measured (e.g., detected) motor angle of the electric motor 520 when the parking brake is applied.

As shown in FIG. 4, when the controller 700 detects a clamp force 408 that satisfies a target clamp force (e.g., target clamp force after application of the parking brake), the controller 700 may determine using the pawl position between teeth 402 and pawl safe position 404 graphs whether the parking pawl 323 will engage with the gear 320 in the unstable parking brake state.

In the example shown in FIG. 4, the clamp force 408 corresponds to a position where the parking pawl 323 will engage with the gear 320 in the unstable parking brake state. As a result, the controller 700 causes the electric motor 520 to rotate more until the controller 700 determines that the parking pawl 323 is positioned above a safe area between the teeth of the gear 320.

Once the controller 700 determines that the parking pawl 323 is positioned above a safe area between the teeth of the gear 320, the controller 700 may cause the parking pawl 323 to engage with the gear 320 within the safe area such that the brake assembly 10 is placed in a stable parking brake state to complete the application of the parking brake.

As a result, using the estimated correlation between the motor angle of the electric motor 520 and the position of each teeth of the parking brake gear, the controller 700 may advantageously determine when the parking pawl 323 (or other similar latch structure) will potentially engage with the gear 320 in the unstable parking brake state and prevent such an engagement.

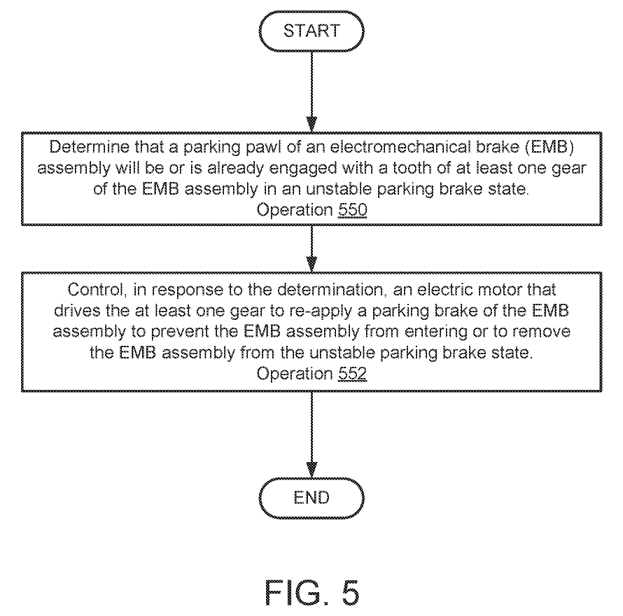

Turning to FIG. 5, FIG. 5 shows a flow chart for illustrating a method for controlling a parking brake of an EMB assembly according to an exemplary embodiment of the present disclosure. The method may be applied (e.g., executed) by, for example, controller 700 of the brake assembly 10. The method may also be executed by any other computing-system installed within the vehicle that is installed with the brake assembly 10 provided that the other computing-system is connected with (e.g., is able to communicate and exchange date with) the controller 700 of the brake assembly 10.

In Operation 550 of FIG. 5, as discussed above in refernce to FIGS. 2A-4, the controller 700 may determine that the parking pawl of an EMB assembly will be or is already engaged with a tooth of at least one gear (e.g., driven pulley 543 of FIG. 1) of the EMB assembly in an unstable parking brake state.

In Operation 552, as discussed above in refernce to FIGS. 2A-4, the controller 700 may control (e.g., in response to the determination in Operation 550), an electric motor that drives the at least one gear to re-apply a parking brake of the EMB assembly to prevent the EMB assembly from entering or to remove the EMB assembly from the unstable parking brake state.

The method of FIG. 5 may end following Operation 552.

Any vehicle according to certain exemplary embodiments of the present disclosure may be identical, or substantially similar to, vehicle 800 shown in FIG. 6. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 6 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) assembly comprising:
a brake pad assembly;
an electric motor mechanically connected to the brake pad assembly via at least one gear having teeth to apply a parking brake to place the EMB assembly in a parking brake enabled state;
a parking lock mechanism comprising a parking pawl that prevents release of the brake pad assembly from the parking brake enabled state; and
a controller electrically connected to the electric motor and configured to control the electric motor to re-apply the parking brake in response to the controller determining that the parking pawl will be or is already engaged with the teeth of the at least one gear in an unstable parking brake state.

2. The EMB assembly of claim 1, wherein the unstable parking brake state comprises a terminal end of the parking pawl that engages with the teeth of the at least one gear being engaged against a top land of a gear tooth among the teeth of the at least one gear.

3. The EMB assembly of claim 2, wherein the re-applying of the parking brake prevents the parking pawl from being engaged against the top land of the gear tooth to place the parking pawl between a notch between the teeth of the at least one gear.

4. The EMB assembly of claim 2, wherein the determination by the controller is based on a position of the electric motor measured by the controller before a ramping down of a motor torque that occurs when the parking brake is applied.

5. The EMB assembly of claim 4, wherein the determination by the controller comprises, by the controller:
measuring a first motor position of the electric motor before the ramping down of the motor torque that occurs when the parking brake is applied;
measuring a second motor position of the electric motor after a predetermined time after the ramping down of the motor torque; and
using the first motor position and the second motor position to determine whether the parking pawl is engaged with the teeth of the at least one gear in the unstable parking brake state.

6. The EMB assembly of claim 5, wherein the determination by the controller further comprises, by the controller:
calculating a difference between the second motor position and the first motor position;
comparing the difference to a predetermined motor position difference threshold;
in a first instance where the difference exceeds the predetermined motor position difference threshold, determining that the parking pawl is not engaged with the teeth of the at least one gear in the unstable parking brake state; and
in a second instance where the difference is below the predetermined motor position difference threshold, determining that the parking pawl is engaged with the teeth of the at least one gear in the unstable parking brake state.

7. The EMB assembly of claim 5, wherein the determination by the controller further comprises, by the controller:
determining that the first motor position is substantially identical to the second motor position; and
determining, based on the first motor position being substantially identical to the second motor position, that the parking pawl is engaged with the teeth of the at least one gear in the unstable parking brake state.

8. The EMB assembly of claim 5, wherein
the controller further measures the motor torque as the parking brake is applied, and
the second motor position is measured when the controller determines that the motor torque has decreased by at least half from a maximum motor torque measured by the controller after the parking brake is applied.

9. The EMB assembly of claim 5, wherein
the controller further measures the motor torque as the parking brake is applied, and
the second motor position is measured when the controller determines that the motor torque has decreased by at least a quarter from a maximum motor torque measured by the controller after the parking brake is applied.

10. The EMB assembly of claim 5, wherein
the controller further measures the motor torque as the parking brake is applied, and
the second motor position is measured when the controller determines that the motor torque has decreased to an original motor torque measured by the controller at an instant before the motor torque began to ramp up at a start of an application of the parking brake.

11. The EMB assembly of claim 2, wherein the parking pawl is pivotable about a pivot axis between an engaged position where the parking pawl is in contact with the at least one gear and a disengaged position where the parking pawl is not in contact with the at least one gear, and the parking pawl cannot be directly controlled by the controller to pivot between the disengaged position and the engaged position.

12. The EMB assembly of claim 11, wherein the parking pawl is only pivotable between the disengaged position and the engaged position based on a movement of the at least one gear when the parking brake is applied.

13. The EMB assembly of claim 2, wherein the determination by the controller is based on an angle of each of the teeth of the at least one gear at a time when the parking brake is applied.

14. The EMB assembly of claim 13, the angle of each of the teeth is based on an angle of the electric motor.

15. The EMB assembly of claim 13, wherein the controller uses the angle of each of the teeth at the time when the parking brake is applied to determine a parking pawl safe position and a position of the parking pawl between the teeth.

16. The EMB assembly of claim 15, wherein the controller further:
determines whether a target clamp force has been reached after the parking brake is applied; and
determines when the target clamp force has been reached, whether the parking pawl will be engaged with the teeth of the at least one gear in the unstable parking brake state using the parking pawl safe position and the position of the parking pawl between the teeth.

17. The EMB assembly of claim 16, wherein, in an event that the controller determines that the parking pawl will be engaged with the teeth of the at least one gear in the unstable parking brake state, the controller causes the electric motor to move the at least one gear until the parking pawl reaches at least one safe area indicated by the parking pawl safe position.

18. The EMB assembly of claim 16, wherein, in an event that the controller determines that the parking pawl will not be engaged with the teeth of the at least one gear in the unstable parking brake state, the controller causes the EMB assembly to actuate the parking pawl to engage with the at least one gear between at least one notch of the teeth of the at least one gear.

19. A method comprising:
determining, by an electronic controller of an electromechanical brake (EMB) assembly, that a parking pawl of the EMB assembly will be or is already engaged with a tooth of at least one gear of the EMB assembly in an unstable parking brake state; and
controlling, by the electronic controller and in response to the determination, an electric motor that drives the at least one gear to re-apply a parking brake of the EMB assembly to prevent the EMB assembly from entering or to remove the EMB assembly from the unstable parking brake state.

20. The method of claim 19, wherein the electric motor is mechanically connected to a brake pad assembly of the EMB assembly via the at least one gear having teeth to apply the parking brake to place the EMB assembly in a parking brake enabled state, and parking pawl is part of a parking lock mechanism that prevents release of the brake pad assembly from the parking brake enabled state.
